(19) United States
(12) Patent Application Publication
(10) Pub. No.: US 2026/0348335 A1
(43) Pub. Date: Nov. 5, 2026

(54) Off-Road Vehicle And Engine Braking Method Thereof

(71) Applicant: Zhejiang CFMOTO Power Co., Ltd., Hangzhou (CN)

(72) Inventors: Xiaoxuan Ji, Hangzhou (CN); Hao Lan, Hangzhou (CN); Baiyang Wang, Hangzhou (CN); Yaohui Yang, Hangzhou (CN); Jiahui Li, Hangzhou (CN); Linglong Meng, Hangzhou (CN)

(21) Appl. No.: 19/663,223

(22) Filed: Apr. 29, 2026

(30) Foreign Application Priority Data
Apr. 30, 2025 (CN) 202510561811.7

(51) Int. Cl. F02D 41/12; B60K 17/06; B60K 17/34; B60K 26/02

(52) U.S. Cl. CPC F02D 41/12; B60K 17/06; B60K 17/34; B60K 26/02; F02D 2200/101; F02D 2200/501

(57) ABSTRACT

An electrical system of an off-road vehicle includes a throttle control position sensor and a control module. The control module is configured to determine an acceleration of the off-road vehicle. If the throttle control has not been recently pressed for a preset duration such that the engine is likely in an idling state, and if the acceleration of the off-road vehicle is greater than an acceleration threshold, the control module is capable of controlling the off-road vehicle to perform engine braking. Other factors affecting the engine braking control logic can include vehicle speed, gear selection status, four-wheel drive status, engine brake switch status, pitch angle and corresponding durations of each. The method can improve the accuracy of triggering engine braking by adjusting the parameters of throttle control travel and acceleration, thereby enhancing the safety and stability of off-road vehicles particularly when going down a hill.

### RELATED APPLICATION INFORMATION

The present application claims priority to Chinese patent application No. 202510561811.7, filed on Apr. 30, 2025, the entire contents of which are incorporated herein by reference.

### FIELD OF THE DISCLOSURE

The present invention relates to the field of vehicle braking control, and particularly to an off-road vehicle and engine braking method thereof.

### BACKGROUND OF THE DISCLOSURE

Utility Vehicles (“UTVs”) are a well-known type of off-road vehicle, and are widely used by farmers and ranchers. UTVs have a large suspension travel and excellent off-road capability, and are also used in mining, wilderness, beach off-road and mountainous cargo scenarios. Recreational Utility Vehicles (“RUVs”) are leisure type multi-purpose vehicles with strong power, strong off-road capabilities, and a certain amount of cargo space, making it suitable for unknown road environments in the wild. All-terrain vehicles (ATVs) are another type of vehicle suitable for driving on various terrains, also known as “beach vehicles” or “all terrain four-wheel off-road motorcycles”. ATVs typically have a straddle-type seat and provide excellent off-road performance, capable of driving on beaches, riverbeds, forest trails, streams, and harsh desert terrain. As used herein, “off-road” vehicles include UTVs, RUVs and ATVs.

Engine braking can be used on a wide variety of UTV/RUV/ATV models, reducing the need for drivers to apply the brakes during downhill driving, and often saving on fuel economy. In related technologies, engine braking can be electronically controlled using inputs of vehicle pitch angle, throttle control status, braking status, and engine rotational speed. As used herein, engine braking involves using engine compression and/or alternator drag to generate a braking force tending to slow wheel rotation, with torque in the drive train being transmitted opposite its normal direction, i.e., from the wheels to the engine (and alternator) rather than from the engine to the wheels. In vehicles with fuel injection, typically the fuel injectors are controlled so no fuel is injected during engine braking, enhancing fuel economy.

In UTV/RUV/ATV models, there is a problem with accurately determining engine braking based solely on pitch angle of the vehicle body. The angle sensor is typically installed in the middle of the UTV/RUV/ATV vehicle body, above the suspension. On one hand, the pitch angle of the vehicle body can change depending upon when the cargo body is loaded or when the empty. On the other hand, rapid acceleration or deceleration and traversing over obstacles can significantly change the pitch angle of the UTV/RUV/ATV vehicle body, which can cause engine braking to be accidentally triggered or can prevent engine braking from being timely engaged when desired. Therefore, it is impossible to accurately determine whether engine braking needs to be triggered solely using angle signals, which in turn affects the safety and stability of the vehicle when going down a hill.

### SUMMARY OF THE INVENTION

In order to address the shortcomings of existing technology, the purpose of this application is to provide a safe and stable all-terrain vehicle and its engine braking method.

In a first aspect, the invention is an off-road vehicle which can perform engine braking. The off-road vehicle includes a prime mover assembly, a plurality of wheels, a drive train, a throttle control and an electrical system with a control module capable of controlling the off-road vehicle to perform engine braking. The prime mover assembly includes an engine for generating torque for the off-road vehicle to move and a continuously variable transmission used to couple and uncouple the engine and the drive train, including adjusting relative rotational speed ratios between the engine and the drive train. The drive train transfers torque output by the prime mover assembly to the plurality of wheels. The throttle control is used by the driver for controlling output torque of the engine. In addition to the control module, the electrical system includes a throttle control position sensor. The throttle control position sensor detects a position or stroke of the throttle control as moved by the driver. The control module initiates engine braking only if at least two conditions are met, namely that a) throttle control travel is less than a first stroke threshold for a first preset duration and b) acceleration of the off-road vehicle is greater than an acceleration threshold.

In another aspect, the invention is a method of performing engine braking which includes at least four steps. The engine braking steps include a) detecting a position of a throttle control of the off-road vehicle, b) determining whether throttle control travel has been less than a first stroke threshold for a first preset duration, and c) determining acceleration of the off-road vehicle. Then, if throttle control travel has been less than a first stroke threshold for a first preset duration and acceleration of the off-road vehicle is greater than an acceleration threshold, the method d) controls the off-road vehicle to perform engine braking. The method improves accuracy of triggering engine braking based on the throttle control state and acceleration parameters, thereby enhancing the safety and stability when the all-terrain vehicle goes down a hill.

In another aspect, the off-road vehicle and/or its method of performing engine braking, determines whether at least one different condition (i.e., a condition other the duration since the driver has significantly pressed the throttle control) has continued in excess of a second preset duration prior to initiating engine braking. For instance, the control module is capable of determining acceleration of the off-road vehicle. Then, provided throttle control travel is currently less than a first stroke threshold, the control module will control the off-road vehicle to initiate engine braking once acceleration of the off-road vehicle has been greater than an acceleration threshold for an acceleration-check preset duration (which may be the same duration or a different duration than the preset duration discussed above in the first aspect, and without necessarily requiring throttle control travel to have been maintained less than the first stroke threshold for a given period of time).

### BRIEF DESCRIPTION OF THE DRAWINGS

FIG. 1 shows a rear left perspective view of an all-terrain vehicle according to a preferred embodiment of the present invention;

FIG. 2 is a schematic diagram of the all-terrain vehicle of FIG. 1 for performing engine braking according to the present invention;

FIG. 3 shows a predefined curve of engine speed to vehicle velocity, with no torque transference in the CVT in either direction, of the all-terrain vehicle of FIG. 1;

FIG. 4 is a flowchart of the preferred control logic in the control module of FIG. 2 to perform engine braking according to the present invention in the all-terrain vehicle of FIG. 1;

FIG. 5 is a schematic diagram of the prime mover assembly and an alternative electrical system for the all-terrain vehicle of FIG. 1 for performing engine braking according to the present invention;

FIG. 6 is a flowchart of an additional step in activating engine braking in accordance with the present invention;

FIG. 7 is a flowchart of the preferred control logic in the control module of FIG. 2 or 5 to discontinue engine braking in accordance with the present invention;

FIG. 8 is a flowchart of alternative preferred control logic in the control module of FIG. 5 to perform engine braking according to the present invention in the all-terrain vehicle of FIG. 1.

### DETAIL DESCRIPTION

For better understanding the purpose, technical solution, and advantages of the present invention, the following detailed explanations are provided of preferred embodiments. It should be noted that the embodiments described herein are only used to explain the invention and are not intended to limit the coverage defined by the attached claims.

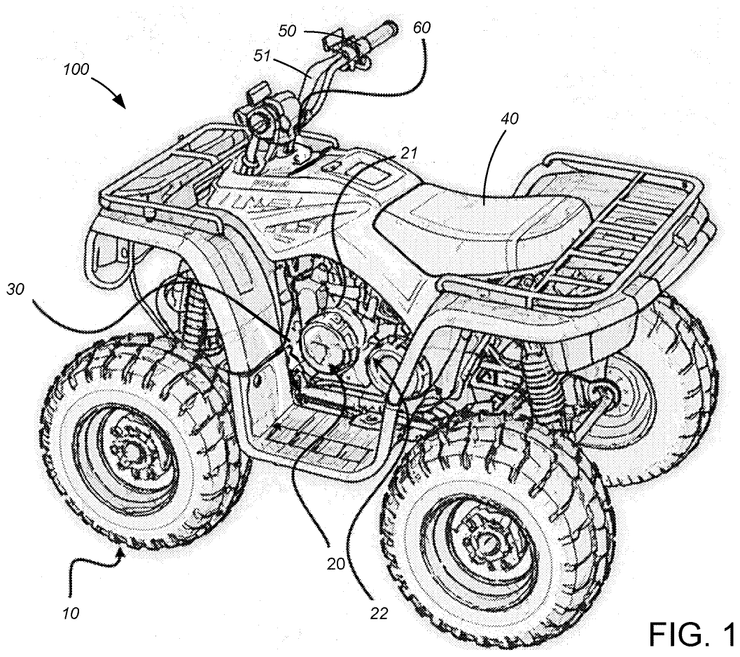

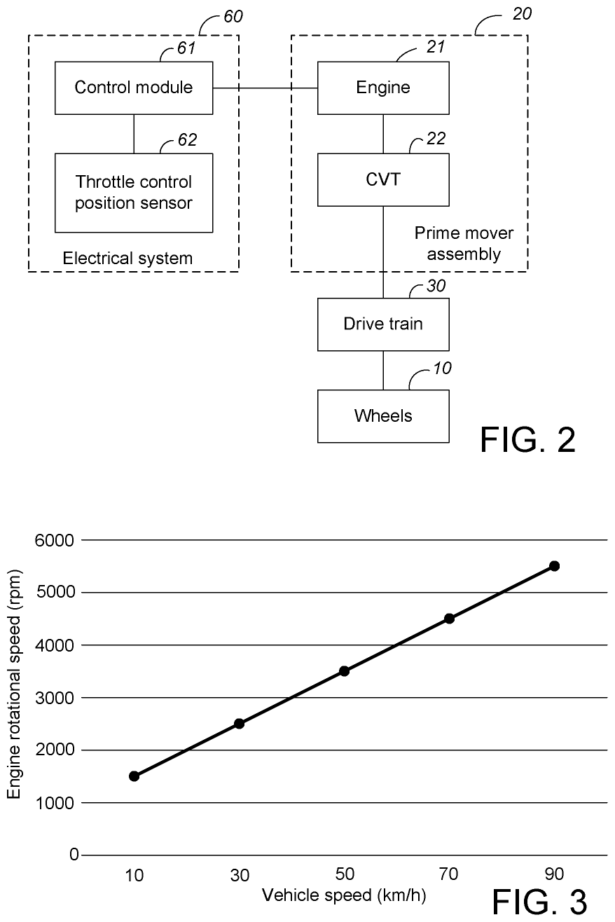

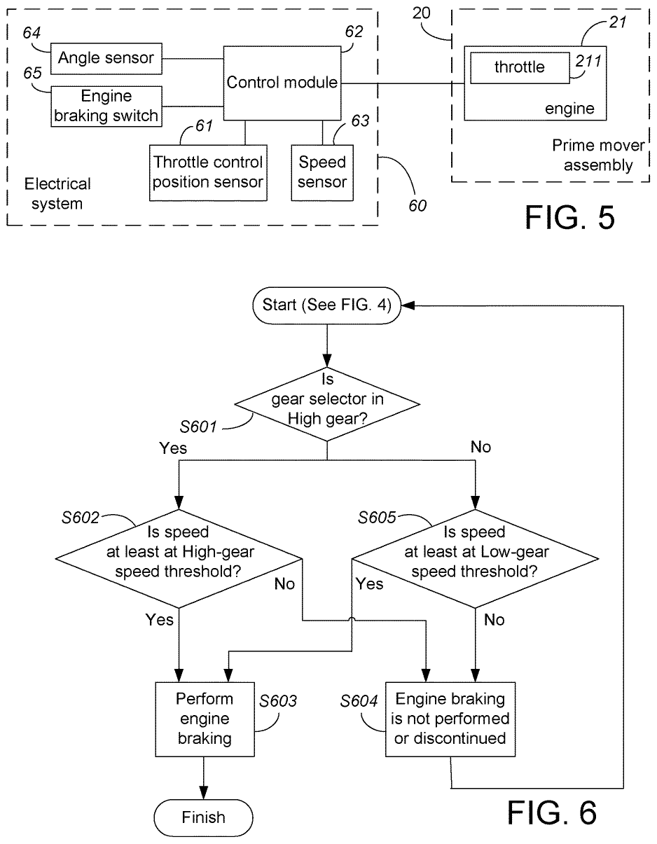

FIG. 1 shows a preferred all-terrain vehicle 100 incorporating the present invention. The all-terrain vehicle 100 includes a plurality of wheels 10, a prime mover assembly 20, a drive train 30, seating 40, a throttle control 50, and an electrical system 60. The plurality of wheels 10 are used to drive the all-terrain vehicle 100 to travel, preferably including low pressure tires for passing over rough terrain. The prime mover assembly 20 is used to output torque, and the prime mover assembly 20 preferably includes an internal combustion engine 21 and a continuously variable transmission (“CVT”) 22. A throttle plate or throttle valve 211 (shown schematically in FIG. 5) is used to control combustion air flowrate into the engine 21 and thereby control the torque output of the engine 21. The drive train 30 is used to transmit the torque output from the prime mover assembly 20 to at least some of the plurality of wheels 10. The drive train 30 includes mechanical components such as drive shafts, differentials or drive axle assemblies and half shafts (all not separately shown). The CVT 22 is used to couple and uncouple the engine 21 and the drive train 30, including adjusting relative rotational speed ratios between the engine 21 and the drive train 30. The seating 40 in this embodiment is a straddle seat, but in other embodiments can be bucket or bench seating (not shown) including in a side-by-side relationship for the driver and possibly one or more passengers, possibly in multiple rows. The throttle control 50 allows the driver to control torque output of the engine 21 via movement of the throttle valve 211. On some embodiments, the throttle control 50 can be a pedal pushed by the driver's foot, while the preferred embodiment includes a hand operated throttle control 50 supported on handlebars 51. The electrical system 60 includes at least a throttle control position sensor 61 and a control module 62 (both shown schematically in FIG. 5). The preferred throttle control position sensor 61 is used to detect a stroke/position of the throttle control 50. For example, the throttle control position sensor 61 may be a displacement sensor or potentiometer used to detect the stroke of the throttle control 50. In most embodiments, the position of the throttle plate/valve 211 is directly controlled by the throttle control 50, at least in the vast majority of riding scenarios. In some embodiments, other systems such as cruise control, traction control, idle speed management, and emission control systems may influence the position of the throttle plate/valve 211. In such embodiments, an additional or alternative throttle plate position sensor (not shown) may be used if it is desired to base engine braking off the position of the throttle plate/valve 211 in addition to or instead of the throttle control position sensor 61. The control module 62 may be a micro-controller or electronic control unit (ECU). The control module 62 is configured to control the engine 21, not only in response to the throttle control 50 but also to perform engine braking at certain times when the throttle control position is less than a first stroke threshold.

Specifically, when the position of throttle control 50 is at or close to a fully released state for a preset duration, if the all-terrain vehicle 100 is accelerating and/or not sufficiently deceleration (both referred to herein as exceeding an acceleration threshold), the control module 62 is capable of controlling the engine 21 and CVT 22 of the all-terrain vehicle 100 to perform engine braking. The value of the preset duration used is typically the approximate amount of time for the engine 21, following full release of the throttle control 50, to enter an idle state. Thus, once the position of throttle control 50 is at or close to a fully released state for a preset duration, the engine is typically (though not always, as other factors can affect engine speed) idling, with the throttle plate/valve 211 substantially or entirely closed to an idle position. Correctly applied engine braking enhances safety and stability particularly when the all-terrain vehicle 100 goes down a hill.

In the preferred embodiment, as the control module 62 initiates engine braking, the control module 62 is capable of increasing the rotational speed of the engine 21 to ensure that the rotational speed of the engine 21 matches the rotational speed of the drive train 30 based on vehicle speed of the all-terrain vehicle 100, avoiding the risk of jerk as the clutch of the CVT 22 engages, thereby minimizing the risk of loss of control and improving safety during downhill driving. The control module 62 dynamically adjusts engine speed based on the known correspondence between the actual travelling speed of the all-terrain vehicle 100 and drive train rotational speed (with the clutch engaged while no torque is being transferred in the CVT 22 between the engine 21 and the drive train 30), in order to achieve smoother engine braking. For example, when the all-terrain vehicle 100 is traveling downhill at a fast speed while the engine speed is relatively low, the control module 62 increases the engine rotational speed accordingly to match the drive train speed as part of initiating engine braking. Though it is unusual to have high engine speeds while the throttle control 50 is at or close to a fully released state for the preset duration, some embodiments further allow the control module 62 to reduce engine speed if it exceeds drive train speed during relatively lower speed vehicle travel.

In the preferred embodiment, the corresponding relationship includes a high-gear dataset and a low-gear dataset. Each dataset includes a predefined curve or a predefined correlation table of vehicle speed versus engine rotational speed at no torque transference, either for when the all-terrain vehicle 100 is in High gear (“H”) or Low gear (“L”) on a P-R-N-H-L gear selector.

The high-gear dataset and the low-gear dataset may be pre-calibrated through experiments or simulations, which can reflect the matching relationship between vehicle speed and engine rotational speed in different gears without torque transfer in the CVT 22. When the control module 62 performs engine braking, the corresponding dataset is selected according to the current gear, and the engine rotational speed adjusted in real time based on vehicle speed to conform to the predefined curve or predefined correspondence table.

For example, a preferred high-gear predefined curve is shown in the following table and in FIG. 3, with the horizontal axis representing vehicle speed in km/h and the vertical axis representing engine rotational speed in rpm.

| Vehicle speed (km/h) | Engine rotational speed (rpm) |
|---|---|
| 10 | 1500 |
| 30 | 2500 |
| 50 | 3500 |
| 70 | 4500 |
| 90 | 5500 |

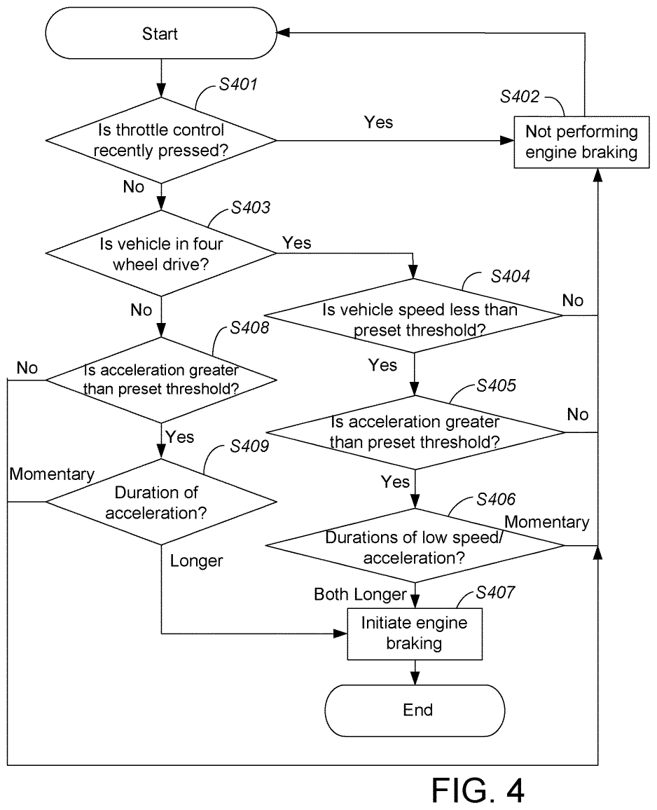

FIG. 4 shows the control logic for a preferred embodiment of the present invention. In addition to checking both the position of throttle control 50 and acceleration of the all-terrain vehicle 100 as prerequisites for initiating engine braking, the preferred control logic performs differently depending upon whether the all-terrain vehicle 100 is in a two-wheel drive mode or a four-wheel drive mode. Namely, if the all-terrain vehicle 100 is in a four-wheel drive mode, the control module 62 does not initiate engine braking at high speeds. Four-wheel drive provides stronger traction and grip as well as higher drive train inertia, and high speed engine braking in four-wheel drive may be difficult for the driver to safely control. In contrast, two-wheel drive provides relatively weaker grip and relatively less drive train inertia (typically because inertia of the front drive shaft, front differential, front half shafts and front wheels is not transferred to the engine 21), and there is no need for additional speed threshold conditions before initiating engine braking.

As shown in FIG. 4, the steps for the control module 62 to control the all-terrain vehicle 100 to initiate engine braking are as follows:

In step S401, the control logic checks position of the throttle control 50. If the driver is positioning the throttle control 50 past the first stroke threshold, then the control logic performs no engine braking in step S402, and returns to Start. If the position of the throttle control 50 is at or close to a fully released state for a first preset duration, then the control logic proceeds to step S403.

In step S403, the control logic determines whether the all-terrain vehicle 100 is in four-wheel drive mode or not. If the all-terrain vehicle 100 is in four-wheel drive mode, the control logic proceeds to step S404. If the all-terrain vehicle 100 is not in four-wheel drive mode (i.e., if all-terrain vehicle 100 is in two-wheel drive mode), the control logic proceeds to step S408.

In step S404, the control logic determines whether vehicle speed is less than a preset speed threshold or not. If the speed of the all-terrain vehicle 100 is greater than or equal to the preset speed threshold, then the control logic performs no engine braking in step S402, and returns to Start. If the speed of the all-terrain vehicle 100 is less than the preset speed threshold, then the control logic proceeds to step S405.

In step S405, the control logic determines whether the acceleration of all-terrain vehicle 100 is greater than the preset four-wheel drive acceleration threshold. If the acceleration of all-terrain vehicle 100 is not greater than the preset four wheel drive acceleration threshold, then the control logic performs no engine braking in step S402, and returns to Start. If the acceleration of all-terrain vehicle 100 is greater than the preset four wheel drive acceleration threshold, then the control logic proceeds to step S406.

Step S406 is an optional step of determining whether the vehicle speed has been less than the preset vehicle speed threshold and the acceleration has been greater than the preset four wheel drive acceleration threshold for a second preset duration or not. The second preset duration of step S406 may be the same as or different from the first preset duration of step S401. If the vehicle 100 has just slowed down or just begun acceleration, then the control logic performs no engine braking in step S402, and returns to Start. If the durations are both greater than or equal to the second preset duration, then the control module 62 initiates engine braking in step S407.

Step S408 is reached when the all-terrain vehicle 100 is in two-wheel drive. Like step S405, the control logic determines whether the acceleration of all-terrain vehicle 100 is greater than an acceleration threshold value, in this case the preset two-wheel drive acceleration threshold. The preset two-wheel drive acceleration threshold may be different from the preset four-wheel drive acceleration threshold, but the preferred embodiment uses the same value for both the preset two-wheel drive acceleration threshold and the preset four-wheel drive acceleration threshold. If the acceleration of all-terrain vehicle 100 is not greater than the preset two wheel drive acceleration threshold, then the control logic performs no engine braking in step S402, and returns to Start. If the acceleration of all-terrain vehicle 100 is greater than the preset two wheel drive acceleration threshold, then the control logic proceeds to step S409.

Like step S406, step S409 is an optional step of determining whether the acceleration has been greater than the preset two wheel drive acceleration threshold for a third preset duration or not. The third preset duration of step 409 may be the same as or different from the first preset duration of step 401, and may be the same as or different from the second preset duration of step 406. If the vehicle 100 has just begun acceleration, then the control logic performs no engine braking in step S402, and returns to Start. If the duration is greater than or equal to the third preset duration, then the control module 62 initiates engine braking in step S407.

This preferred control logic enables precise control of the engine braking function based on different driving modes and states of the all-terrain vehicle 100, improving the adaptability and safety of engine braking and ensuring effective assistance to drivers in controlling vehicle speed under various working conditions.

FIG. 5 shows an embodiment wherein acceleration of the all-terrain vehicle 100 is determined via a speed sensor 63 of the electrical system 60. The control module 62 obtains continuous vehicle speed data provided by the speed sensor 63, and derives real-time acceleration of the all-terrain vehicle 100 by calculating change in vehicle speed per unit time (e.g. using differential or integral algorithms). For example, if vehicle speed increases from v₁ to v₂ within Δt time, then acceleration a=(v₂−v₁)/Δt. This method enables the control module 62 to obtain accurate acceleration information for the engine braking function without relying on an accelerometer signal subject to gravitational effects due to changing vehicle pitch and vehicle loading effects affecting vehicle pitch, thereby achieving more precise braking control. Alternative embodiments use an accelerometer or inertial measurement unit (IMU) to measure the acceleration and/or tilt angle of the all-terrain vehicle 100.

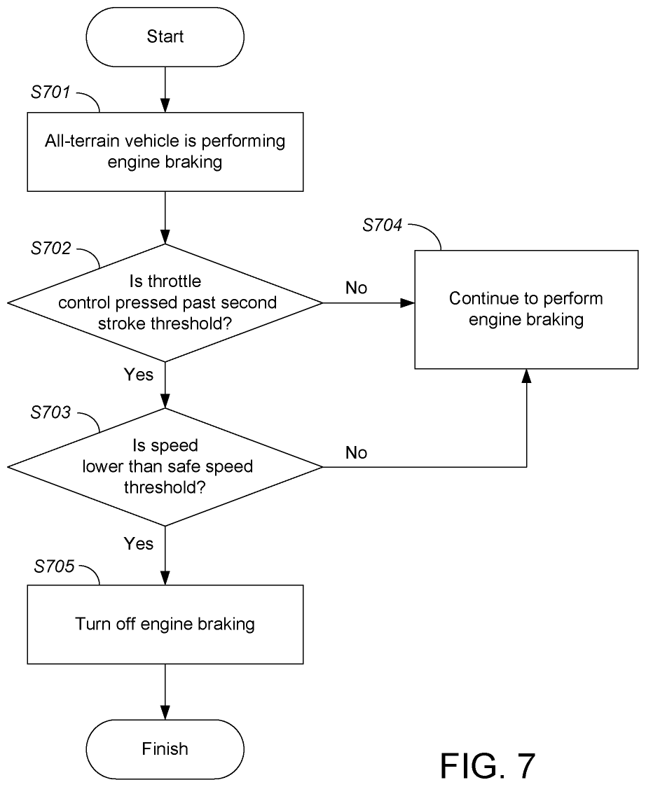

FIG. 6 shows acquisition of gear position of the all-terrain vehicle 100 for performing engine braking. If the all-terrain vehicle 100 is in High gear position and vehicle speed is not less than a high-gear speed threshold, then the control module 62 activates the engine braking function. If the all-terrain vehicle 100 is in Low-gear position and vehicle speed is not less than a Low-gear speed threshold, then the control module 62 activates the engine braking function. The High-gear speed threshold is greater than the Low-gear speed threshold. If the all-terrain vehicle 100 slows below the respective High- or Low-gear speed threshold, then the control module 62 discontinues this occurrence of engine braking.

In addition to the steps in FIG. 4, the control module 62 controls engine braking of the all-terrain vehicle 100 based on gear position, that is, using step S601 as a new judgment condition in executing the engine braking in step S407 of FIG. 4. In step S601, the control logic determines whether the P-R-N-H-L gear selector of the all-terrain vehicle 100 is in High-gear position or not. If the all-terrain vehicle 100 is in High gear, the control logic proceeds to step S602. If the all-terrain vehicle 100 is not in High gear (such as when in Low gear), the control logic proceeds to step S605.

In step S602, the control logic determines whether vehicle speed is not less than the High-gear speed threshold. The value for the High-gear speed threshold may be the same as or different from the value for the preset speed threshold of step S404. If vehicle speed is equal to or greater than the High-gear speed threshold, then the control module 62 initiates engine braking in step S603, continuing engine braking until vehicle speed decreases below the High-gear speed threshold or the driver presses the throttle control 50. If vehicle speed is less than the High-gear speed threshold, then no engine braking is performed in step S604.

In step S605, the control logic determines whether vehicle speed is not less than the Low-gear speed threshold. The value for the Low-gear speed threshold may be the same as or different from the value for the High-gear speed threshold of step S602, and may be the same as or different from the value for the preset speed threshold of step S404. If vehicle speed is equal to or greater than the Low-gear speed threshold, then the control module 62 initiates engine braking in step S606, continuing engine braking until vehicle speed decreases below the Low-gear speed threshold or the driver presses the throttle control 50. If vehicle speed is less than the High-gear speed threshold, then no engine braking is performed in step S604.

This method matches initiation of the engine braking function with the gear and vehicle speed 100, thereby ensuring that appropriate braking assistance can be provided according to the actual driving speed in different gears, thereby effectively preventing insufficient or excessive braking caused by excessive speed or gear mismatch. Other embodiments may include gear selection with more gears than just P-R-N-H-L, and gear speed thresholds and corresponding comparisons can be included for each forward gear.

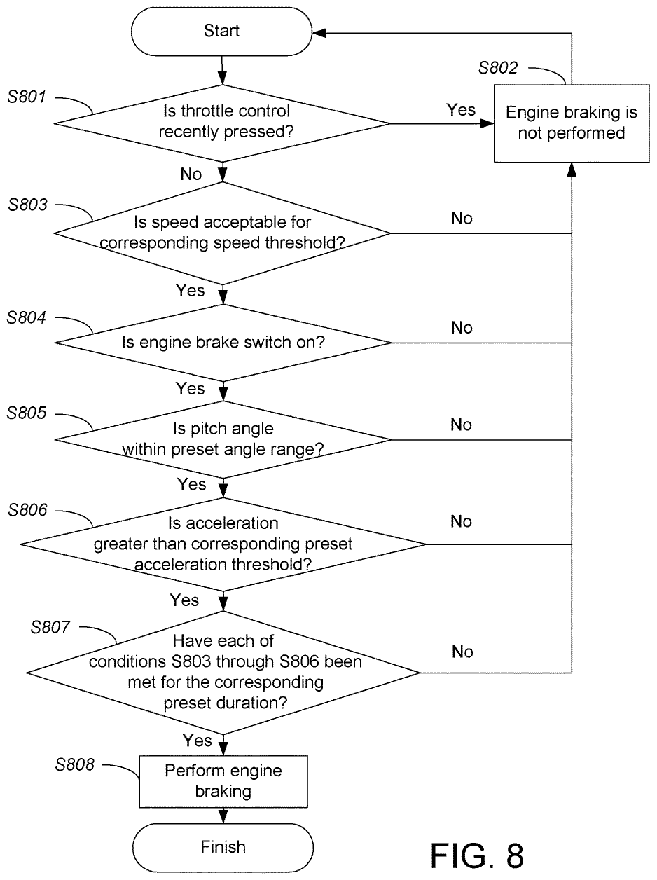

FIG. 7 shows an alternative embodiment where a second stroke threshold is used to discontinue engine braking, the second stroke threshold being different from the first stroke threshold. If throttle control travel is greater than a second stroke threshold and vehicle speed is less than a safe speed threshold, then the control module 62 discontinues engine braking. The second stroke threshold is preferably greater than the first stroke threshold. The safe speed threshold may be the same as or different from the Low-gear speed threshold of step S605, may be the same as or different from the value for the High-gear speed threshold of step S602, and may be the same as or different from the value for the preset speed threshold of step S404.

For example, in some complex road conditions, the driver may need to accelerate appropriately to overcome obstacles or adjust the attitude of the all-terrain vehicle 100. If the engine braking function continues to work, it may lead to insufficient power for the all-terrain vehicle 100, affecting the driver's handling of the all-terrain vehicle 100. Therefore, when throttle control travel is greater than the second stroke threshold and vehicle speed is lower than the safe speed threshold, the engine braking function is turned off to ensure powerful and safe driving of the all-terrain vehicle 100 at low speeds.

The steps for the control module 62 to turn off engine braking are thus as follows:

In step S701, the all-terrain vehicle 100 is performing engine braking. In step S702, the control logic determines whether the driver has depressed the throttle control 50 past the second stroke threshold. If the throttle control 50 is past the second stroke threshold, then the control logic proceeds to step S703. If the throttle control travel is not greater than the second stroke threshold, then the control module 62 continues to perform engine braking in step S704.

In step S703, the control logic determines whether vehicle speed is less than the safe speed threshold. If vehicle speed is above the safe speed threshold, then the control module 62 continues to perform engine braking in step S704. If vehicle speed is less than the safe speed threshold, then the current session of engine braking is discontinued in step S705.

This method can flexibly adjust the engine braking control strategy based on the driver's operating intention and the real-time status of the all-terrain vehicle 100, avoiding excessive intervention in the driving of the all-terrain vehicle 100 without the need for braking.

The preferred electrical system 60 further includes an angle sensor 64 as shown in FIG. 5. The angle sensor 64 is configured to obtain a pitch angle of the all-terrain vehicle 100. In vehicles equipped with the angle sensor 64, the conditions for the control module 62 to control the all-terrain vehicle 100 to perform engine braking further include verifying that the pitch angle of the all-terrain vehicle 100 is within a preset angle range for a preset duration. This method ensures that the engine braking function is only activated when the all-terrain vehicle 100 when desired, (typically within a prolonged downhill condition), effectively avoiding false triggering caused by uneven road surfaces or brief tilts when traversing over obstacles, improving the accuracy and reliability of braking control, and enhancing the adaptability and safety of the all-terrain vehicle 100 in complex terrains. The angle sensor 64 is preferably an inclination sensor which can measure the inclination angle of the all-terrain vehicle 100 relative to horizontal, providing accurate information on the vehicle's pitch state for the control module 62.

As also shown in FIG. 5, the preferred electrical system 60 further includes an engine braking switch 65. In vehicles equipped with the engine braking switch 65, the conditions for the control module 62 to control the all-terrain vehicle 100 to perform engine braking further include that the engine braking switch 65 has been triggered by the driver.

For example, if the driver knows the route will involve prolonged downhill slopes and desires to have engine braking for such downhill slopes, the driver will turn on the engine braking switch 65 in advance. The control module 62 will only execute engine braking after detecting that the engine braking switch 65 is on, combined with other conditions (such as throttle control position, acceleration, etc.). This method ensures that the activation of the engine braking function is completely determined by the driver's will, enhancing driving autonomy and safety, effectively avoiding false triggering, and making the engine braking control of the all-terrain vehicle 100 more precise and reliable.

FIG. 8 shows control logic which matches all these additional conditions. In step S801 (like step S401), the control logic checks position of the throttle control 50. If the driver is positioning the throttle control 50 past the first stroke threshold, then the control logic performs no engine braking in step S802, and returns to Start. If the position of the throttle control 50 is at or close to a fully released state for a first preset duration, then the control logic proceeds to step S803.

In step S803, the control logic registers the two-wheel versus four wheel drive operating status and the High-gear versus Low-gear gear selector status of the all-terrain vehicle 100, and determines whether vehicle speed is acceptable for the corresponding vehicle speed thresholds (less than the preset speed threshold if in four wheel drive, and greater than the corresponding Low-gear or High-gear speed threshold). If vehicle speed passes the corresponding vehicle speed thresholds, then the control logic proceeds to step S804. Otherwise, the control logic performs no engine braking in step S802, and returns to Start.

In step S804, the control logic determines whether the engine braking switch 65 is turned on. If the engine braking switch 65 is off, then the control logic performs no engine braking in step S802, and returns to Start. If the engine braking switch 65 is on, then the control logic proceeds to step S805.

In step S805, the control logic determines whether pitch angle obtained by the angle sensor 64 is within the preset angle range. If the pitch angle is outside the preset angle range, then the control logic performs no engine braking in step S802, and returns to Start. If the pitch angle is within the present angle range for a sufficient duration, the control logic proceeds to step S806.

In step S806, the control logic determines whether acceleration of the all-terrain vehicle 100 is greater than the corresponding preset acceleration threshold. If the acceleration of all-terrain vehicle 100 is greater than the corresponding preset acceleration threshold, proceed to step S807; otherwise the control logic performs no engine braking in step S802, and returns to Start.

In step S807, the control logic determines whether these various conditions of steps S802 through S806 have been continuing for relevant preset durations or not. If any conditions are deemed momentary, the control logic performs no engine braking in step S802, and returns to Start. If the conditions have continued for duration(s) equal to or greater than the corresponding preset duration each for that condition, then the control module 62 initiates engine braking in step 808.

When the control module 62 controls the all-terrain vehicle 100 to initiate engine braking, the control module 62 preferably controls the engine 21 to match rotational speeds between the engine 21 and the CVT 22 and drive train 30. At any given moment of torque transmission, the rotational speed of the CVT driven pulley wheel N_{driven wheel}, driven by the CVT belt can be calculated using the following formula:

N_{driven wheel}=N_{engine}*D_{driving wheel}/D_{driven wheel};

in which, N_{engine} is the rotational speed of the engine 21 (usually expressed in revolutions per minute rpm), D_{driving wheel} is the effective diameter of the CVT driving pulley wheel, and D_{driven wheel} is the effective diameter of the CVT driven pulley wheel. For example, if the engine 21 rotational speed is 2000 rpm, the effective diameter of the CVT driving pulley wheel is 50 mm, and the effective diameter of the CVT driven pulley wheel is 100 mm, the rotational speed of the CVT driven pulley wheel will be: 2000×0.5=1000 rpm. If the engine 21 is rotating too slowly, the control module 62 can gradually increase the rotational speed of the engine 21 to the coupling speed of the drive train 30 through the effective gear ratio of the CVT at any given moment.

Note that the order of performing steps S801 and S803-S807 can generally be rearranged as desired for any particular implementation of the present invention. One or more of these steps can be omitted in some embodiments to reduce complexity or cost. Based on the same inventive concept, the above referenced engine braking steps can be employed in a different order of operations, and/or one or more of the preferred engine braking steps or structures can be omitted while enjoying the benefits of other disclosed engine braking steps and structures.

The above description only expresses specifics and details of several embodiments of the present invention, and should not be understood as unduly limiting the scope of the present patent invention. For ordinary technical personnel in this field, several modifications and improvements can be made without departing from the concept of this invention, which are within the scope of protection of this application. Therefore, the scope of protection should be based on the attached claims.

1. An off-road vehicle comprising
a prime mover assembly for providing torque;
a plurality of wheels;
a drive train for transferring torque output by the prime mover assembly to the plurality of wheels;
a throttle control for controlling output torque of the engine in response to a driver's operation;
wherein the prime mover assembly comprises:
an engine for generating torque; and
a continuously variable transmission used to couple and uncouple the engine and the drive train, including adjusting relative rotational speed ratios between the engine and the drive train; and
an electrical system comprising:
a throttle control position sensor for detecting a stroke of the throttle control; and
a control module capable of controlling the off-road vehicle to perform engine braking if throttle control travel is less than a first stroke threshold for a first preset duration and acceleration of the off-road vehicle is greater than an acceleration threshold.

2. The off-road vehicle according to claim 1, wherein when the control module controls the off-road vehicle to initiate engine braking, the control module is capable of adjusting engine rotational speed based on correspondence between a) engine rotational speed while the continuously variable transmission couples the engine and the drive train, and b) vehicle speed.

3. The off-road vehicle according to claim 2, wherein the correspondence between vehicle speed and engine rotational speed comprises a high-gear dataset and a low-gear dataset, the high-gear dataset comprising a first predefined numerical relationship between vehicle speed and engine rotational speed when the off-road vehicle is in High gear, the low-gear dataset comprising a second predefined numerical relationship between vehicle speed and engine rotational speed when the off-road vehicle is in Low gear.

4. The off-road vehicle according to claim 1, wherein the control module will initiate engine braking only if acceleration of the off-road vehicle is greater than the acceleration threshold for a second preset duration.

5. The off-road vehicle according to claim 1, wherein if the off-road vehicle is in a four-wheel drive mode and vehicle speed is above a vehicle speed threshold, the control module will not cause the off-road vehicle to perform engine braking.

6. The off-road vehicle according to claim 5, wherein the control module will initiate engine braking only if acceleration of the off-road vehicle is greater than the acceleration threshold for a second preset duration.

7. The off-road vehicle according to claim 6, wherein the control module will initiate engine braking only if vehicle speed has remained below the vehicle speed threshold for a third preset duration.

8. The off-road vehicle according to claim 1, wherein the control module determines acceleration of the off-road vehicle based on changes in vehicle speed.

9. The off-road vehicle according to claim 1, wherein the control module is further configured to obtain a gear selector position of the off-road vehicle before controlling the off-road vehicle to perform engine braking, wherein if the off-road vehicle is in High gear and vehicle speed is lower than a high-gear speed threshold, then the control module does not activate engine braking, wherein if the off-road vehicle is in Low gear and vehicle speed is lower than a low-gear speed threshold, then the control module does not activate engine braking, and wherein the high-gear speed threshold is greater than the low-gear speed threshold.

10. The off-road vehicle according to claim 1, wherein if throttle control travel during engine breaking becomes greater than a second stroke threshold and vehicle speed is less than a safe speed threshold, then the control module discontinues engine braking, wherein the second stroke threshold is greater than the first stroke threshold.

11. The off-road vehicle according to claim 1, wherein the electrical system further comprises an angle sensor configured to obtain a pitch angle of the off-road vehicle; wherein engine braking will not be initiated unless pitch angle of the off-road vehicle has remained within a preset angle range for a second preset duration.

12. The off-road vehicle according to claim 1, wherein the electrical system further comprises an engine braking switch which can be triggered by a driver, wherein the control module will only initiate engine braking while the engine braking switch is on.

13. The off-road vehicle according to claim 1, wherein the off-road vehicle is an all-terrain vehicle comprising straddle seating.

14. An engine braking method for an off-road vehicle, the method comprising:
detecting a position of a throttle control of the off-road vehicle;
determining whether throttle control travel has been less than a first stroke threshold for a first preset duration;
determining acceleration of the off-road vehicle; and
if throttle control travel has been less than a first stroke threshold for a first preset duration, and acceleration of the off-road vehicle is greater than an acceleration threshold, controlling the off-road vehicle to perform engine braking.

15. The engine braking method of claim 14, further comprising:
determining whether acceleration has been greater than the acceleration threshold for a second preset duration; and
initiating engine braking only if acceleration of the off-road vehicle has been greater than the acceleration threshold for the second preset duration.

16. The engine braking method of claim 14, further comprising:
adjusting engine rotational speed based on correspondence between a) engine rotational speed while the continuously variable transmission couples the engine and the drive train, and b) vehicle speed;
wherein the correspondence between engine rotational speed and vehicle speed comprises a high-gear dataset and a low-gear dataset, the high-gear dataset comprising a first predefined numerical relationship between vehicle speed and engine rotational speed when the off-road vehicle is in High gear, the low-gear dataset comprising a second predefined numerical relationship between vehicle speed and engine rotational speed when the off-road vehicle is in Low gear.

17. The engine braking method of claim 14, further comprising:
determining whether the off-road vehicle is in four-wheel drive;
determining if vehicle speed is above a vehicle speed threshold; and
if the off-road vehicle is in four-wheel drive, initiating engine braking only if vehicle speed is below the vehicle speed threshold.

18. The engine braking method of claim 17, further comprising:
determining gear selector position of the off-road vehicle;
wherein if the off-road vehicle is in High gear, only initiating engine braking if vehicle speed is higher than a high-gear speed threshold;
wherein if the off-road vehicle is in Low gear, only initiating engine braking if vehicle speed is higher than a low-gear speed threshold;
wherein the high-gear speed threshold is greater than the low-gear speed threshold.

19. The engine braking method of claim 14, further comprising:
while performing engine braking, determining whether throttle control travel is greater than a second stroke threshold, and
if vehicle speed is less than a safe speed threshold while throttle control travel is greater than the second stroke threshold, controlling the off-road vehicle to discontinue engine braking.

20. An off-road vehicle comprising
a prime mover assembly for providing torque;
a plurality of wheels;
a drive train for transferring torque output by the prime mover assembly to the plurality of wheels;
a throttle control for controlling output torque of the engine in response to a driver's operation;
wherein the prime mover assembly comprises:
an engine for generating torque; and
a continuously variable transmission used to couple and uncouple the engine and the drive train, including adjusting relative rotational speed ratios between the engine and the drive train; and
an electrical system comprising:
a throttle control position sensor for detecting a stroke of the throttle control; and
a control module capable of determining acceleration of the off-road vehicle and capable of controlling the off-road vehicle to perform engine braking if acceleration of the off-road vehicle is greater than an acceleration threshold for a preset duration and throttle control travel is less than a first stroke threshold.
